(19) United States
(12) Patent Application Publication
(10) Pub. No.: US 2007/0118449 A1
(43) Pub. Date: May 24, 2007

(54) Trust-linked debit card technology

(76) Inventor: Alain L. De La Motte, Hillsboro, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/478,519

(22) Filed: Jun. 28, 2006

Related U.S. Application Data
(63) Continuation of application No. 11/286,261, filed on Nov. 22, 2005, now abandoned.
(60) Provisional application No. 60/630,234, filed on Nov. 22, 2004.
(60) Provisional application No. 60/630,233, filed on Nov. 22, 2004.
(60) Provisional application No. 60/654,208, filed on Feb. 17, 2005.

(51) Int. Cl. G06Q 40/00

(52) U.S. Cl. 705/35

(57) ABSTRACT

A revenue-producing debit card system and method for users who have bank accounts includes a trust account and plural debit cards. Each debit card is linked to a trust account that allows overnight balances to be invested at a profit for the benefit of the account holder. The system also includes a link between a bank account of a user, a debit card of the user, and the trust account, so that the debit card is linked to a bank account that is a pass-through, net zero balance bank account. The trust account includes a trust sub-account of the user, and the cash balance required to settle card transactions of the user is each time transferred from the trust sub-account of the user. The bank account of the system is used only to book a simultaneous debit and credit for the bank account each time the debit card is used by the user at a remote merchant location, and to report card activity usage. The method also creates a legal structure (e.g. a trust) in which the debit card user is a beneficiary and the user's ownership interest in the trust is evidenced by issuance and delivery of a floating trust-participation receipt. The user's beneficial interest in the trust fluctuates as debits and credits are posted to the user's bank account. The user's percentage ownership in the trust is the pro-rata of his account balance at any point in time relative to the total amount of money in the trust.

### CROSS-REFERENCE TO RELATED APPLICATIONS

This application is a continuation of U.S. patent application Ser. No. 11/286,261, filed Nov. 22, 2005 and entitled “Trust-Linked Debit Card Technology”, which claims priority to U.S. Provisional Patent Application Ser. No. 60/654,208, filed Feb. 17, 2005 and entitled “System & Method for a Non-Banking Entity: (A) to Issue Bank Debit Cards to Customers Via the Issuance and Sale of Card-Linked Notes, and (B) to Control, for Investment Purposes, the Daily Float of the Aggregate Cash Deposits Maintained on Account, While Offering Card Customers 100% Protection Against Loss of Principal Through an Institutional Trust Arrangement; U.S. Provisional Patent Application Ser. No. 60/630,234, filed Nov. 22, 2004 and entitled “System & Method to Cause a Low-Risk Home Equity Loan to be Made to a Homeowner Where the Loan Proceed is Invested Wholly on Partially Through a Trust Arrangement so that the Investment Profits can then be Used to Automatically Repay the First Mortgage and the Home Equity Loan. The Positive Differential Assured Between the Low Interest Cost of the Loan and the Return on Investment is Used to Reduce the Homeowner's Debts” and U.S. Provisional Patent Application Ser. No. 60/630,233, filed Nov. 22, 2004 and entitled “System & Method for a Non-Banking Entity (e.g. A Card Issuer): (A) to Issue Bank Debit Cards or Stored Value Cards to Customers; and (B) to Control, for Investment Purposes, the Daily Float of the Aggregate Cash Deposits Maintained on Account, While Offering Card Customers 100% Protection Against Loss of Principal Through a Bank Trust Arrangement”.

### TECHNICAL FIELD

System & method (the “Technology”) (1) for banking and non-banking companies and groups (e.g. employers' employees; retailers' customers; affinity groups' members/donors; etc. . . . ) to issue and distribute branded Trust-linked debit cards or stored value cards; (2) and for issuers and Cardholders to profit from the Technology by sharing in Trust dividends earned from investments of the consolidated daily overnight balances of all Trust Sub-accounts representing the Trust estate. Unlike traditional debit cards, the Trust-link features this Technology offers allows Cardholders to deposit unlimited amounts in their Trust Sub-accounts without any risk that deposits over and above any insured limit could be lost, as is the case if banks become insolvent and an account balance is in excess of an insured limit.

### BACKGROUND

Debit card availability has put a powerful payment tool in the hands of consumer and business Cardholders. Debit card programs provide Cardholders with convenient, secure access to their funds at automatic teller machines (“ATMs”) and direct merchant purchases. Faster and more convenient than checks, and safer than carrying large amounts of cash, debit card usage continues to experience the most rapid growth of all card products around the world.

A debit card is an electronic method of seamlessly debiting the card holder's bank account for ATM cash withdrawals as well as for merchant purchases. When a debit card is used to make a purchase or to withdraw cash from a checking account, the amount is automatically posted as a debit to the bank account of the cardholder thus eliminating the inconvenience of check writing and the high cost of clearing and settling check transactions for the bank. Even though debit cards offer a convenient and attractive service to the consumer, debit card linked bank accounts rarely pay any interest to the card holder on account balances.

Banks invest depositors' money through loans at rates high enough to cover the lender's cost of funds and operating expenses, plus yield a profit margin for the bank. Even though banks earn a very attractive rate of return on the use of customer deposits, rarely are such profits passed on to the bank's customers; when they are, it is normally in the form of extremely low “teaser” interest rates that have no correlation with the degree and extent of the profits generated by the banks on their customers' assets.

Most consumer and business bank deposits pay no interest, though the banks lend at a significant profit. For example, a $1,000 deposit in a non-interest bearing checking account can be leveraged ten times (10:1 leverage) by the bank through the process known as “fractional reserve banking”. Central banks require banks to maintain a fraction of bank depositors' funds in a non interest-bearing account as a “reserve” to pay depositors in the event they demand their funds back. Central bankers use the Fractional Reserve requirement as a money multiplier in the economy.
As an example, a bank receives deposits of $100 and lends out $90 which the borrower then deposits in the bank. This $90 deposit qualifies as a new deposit that can be lent by the bank after deduction of a 10% ($9) reserve set aside. The bank often receives $81 in a new deposit which the bank can further lend into the market until there is a zeroing out of the amount that can be loaned, at which point a total of $900 will have been made in loans paying full retail bank rates for every $100 of mostly non-interest bearing customer deposits.

The application of this little-understood Fractional Reserve Banking requirement is what allows banks to earn significant profits through the application of two principles of banking: (a) the leverage (currently 10:1 in the USA; 20:1 in Canada; 12.5:1 in Europe, as examples.) of depositor funds that can be loaned or invested (e.g. loans to the government through the purchase of Treasury instruments), and (b) the “Discounting” of loans at an interest rate that is lower (the wholesale rate at which a bank borrows from its Central Bank) than the rate at which funds are lent or placed into the market (retail rate). The compounding of the leverage and discounting principals result in huge profits for the banking industry, assuming that loan defaults are minimized.

There are no known debit cards, credit cards, bank or saving accounts, or financial products available today that simultaneously deliver all of the following benefits and features to a Cardholder of a Trust Linked Debit Card (hereinafter, “TLD Card”):

1. Complete protection against loss of checking account balances over and above an insured limit (e.g. $100,000 in the United States; CA$ 60,000 in Canada;) in the case of a bank's insolvency.

2. The ability of bank depositors to cause small checking account balances to be automatically swept overnight into a large Trustee-managed investment pool designed to deliver superior returns on investment.

3. Automatic participation, through a Trust-managed investment fund, in overnight repo and reverse repo investment strategies or other strategies, normally reserved for financial institutions, major corporations and ultra high net-worth individuals.

4. Automatic reinvestment of profits for increased returns.

5. Ability for individual depositors to aggregate several accounts (e.g. bank accounts, savings accounts, time deposit accounts, money market account and certain retirement accounts) into a single Trust-managed account that offers all the benefits, flexibility and instant accessibility to deposited funds through the TLD Card system in addition to delivering a financial return on all such aggregated overnight balances.

6. Use of a TLD Card to secure 24/7 access to funds for merchant purchases or ATM cash withdrawals worldwide) and to cause a debit to be posted to the Trust sub-account.

7. Access to a secure web-based online banking to manage the account, obtain reports and establish acceptable investment strategies.

### SUMMARY OF THE INVENTION

The Trust-Linked Debit Card (hereinafter “TLD Card”) System which is the object of this invention is a revenue-producing debit card that is linked to a trust account that allows overnight balances to be invested at a profit for the benefit of the account holder. This is accomplished by creating a seamless link between a bank account, a debit card, and a trust account, as illustrated in FIG. 6 attached hereto so that whilst the debit card continues to be technically linked to a bank checking account for legal, regulatory and compliance reasons, its nature and purpose are reduced to that of a “Pass-Through, Net Zero Balance Bank Account” since the cash balance required to settle a card transaction is each time transferred seamlessly and instantly from a Trust Sub-Account of the Cardholder. The bank account only exists to book a simultaneous debit and credit (for the same amount) each time the debit card is used at a remote merchant location and for reporting of card activity purposes.

The TLD Card system uses an institutional trust-relationship to deliver all of the above benefits, flexibility, unique features and protection to individual depositors whose overnight account balances can be safely and legally aggregated through the Trust so as to earn above-average rates that heretofore have only been offered to the most wealthy customers of the private banking divisions of banks and financial institutions.

A key to this proprietary technology is the creation of a legal structure (e.g. a Trust) in which the Cardholder is a Beneficiary and his ownership interest in the Trust Estate has been evidenced by the issuance and delivery of a Floating Trust-Participation Receipt. The Cardholder's beneficial interest in the Trust Estate fluctuates as debits and credits are posted to his account. His percentage ownership in the Trust Estate is the pro-rata of his account balance at any point in time relative to the Total Trust Estate.

The Trustee of the Trust is able to invest the aggregate overnight balances of all sub-accounts for investment purposes in order to earn a return on investment for the trust Beneficiaries. Not only does the TLD Card system pays a return on investment on overnight balances but Cardholders can still have 24×7-access to their cash for bill payments or card charges at ATMs or merchant locations as well greater security than traditional checking or demand deposit accounts. Rather than maintaining cash on deposit in a bank account that pays little or no interest on overnight balances, TLD Cardholders can earn substantial returns through safe and secure pre-defined investments strategies that meet pre-established risk tolerance threshold.

Banks and other financial institutions relish the idea of gaining access to large cash pools available for short-term investments to settle completed securities transactions (repo and reverse repo) or the day's foreign exchange transactions. Such arrangements are normally done through pre-established overnight “sweep instructions” which automatically transfer the aggregated overnight account balances to an account of the institution, along with the requirement that such funds be transferred back to the Trust Sub-account/s at the opening of the following banking day. To gain access to this type of “short term” investment funds, financial institutions are normally willing to pay significant returns that involve little or no risk for the Trust and the associated Trust Sub-accounts. Such sweep agreements and other investment strategies can be structured to deliver superior returns on investment to individual TLD Card holders while maintaining complete safety for the invested principal. Swept funds are transferred at the end of each bank day into an aggregated investment account, as duly permitted by the Cardholders, and returned into the Cardholders' Sub-accounts at the opening of the next banking day.

FIG. 12 is an example of a Trust-Linked Debit Card structure for the Benefit of an Employer and its employees. In this case, the Employees can receive their payroll deposit seamlessly to their account. Employee Cardholders have the choice of either transferring all of part of it to their regular checking account or leaving funds on deposit so that the overnight balance will earn a profit when it is aggregated with other Trust funds of all the other Trust Beneficiaries.

The TLD Card provides the holder with all traditional features and functionality offered by bank debit cards, including cash withdrawals at ATMs, online banking, or making payments at merchant locations worldwide. However, rather than posting debits to a regular checking account, the System posts a debit to a trust sub-account of the card holder and the charged amount to a suspense settlement account that is then used to settle the charge. Additional benefits and features available to individual Cardholders include amongst other things the following:
Unlimited protection from loss of deposit for any amount on deposit in a Trust Sub-account. Trust funds cannot be consolidated with bank assets to settle creditor claims in the event of a bank's insolvency.
Self-determination by the Cardholder of the account balance (the float) percentage to be held in cash by the Trustee and the percentage that can be invested overnight or longer term.
Cardholder selection of the level of the risk threshold acceptable with the overnight investment of deposit funds. Individual Sub-account balances are aggregated and invested overnight by the Trustee in “permitted investments”.
Ability to deposit and post automatic credits for recurring deposits to the trust sub-account or the linked-checking account (e.g. payroll checks, social security checks, insurance checks, alimony payments, etc.).
Ability to convert and hold funds in any major currency.
Investment returns are earned on daily account balances and paid by the Trustee to unit holders on a pro-rata basis of Trust units owned.
Cash balances may be withdrawn in whole or in parts at any time.
Ability to convert back and forth all or part of a sub-account to or from a currency to gold units that appreciate or depreciate with the value of gold relative to the base currency.
Availability of multiple TLD Cards per sub-account (personalized to each individual).
24/7 online banking to transfer funds or pay bills (intra-bank or inter-bank) or send/order certified checks+ability to pre-set recurring transactions or payments.
24/7 access to account balances and real time account activities.
Pin-secured cash withdrawals at ATMs and participating banks worldwide.
Automatic debit of purchases made at merchant locations worldwide.
Card insured for unauthorized use or loss and protected by account lock-in features which are part of other patent applications.
Customer-defined pre-set charge limit for large dollar charges that require phone-in authorization of card holder.
Link of the trust sub-account to one or more bank checking accounts to facilitate the automatic transfer of amounts from the TLD Card so as to maintain a customer-defined minimum checking account balance in each account.

TLD Card accounts offer benefits not historically available to depositors except for high net worth individuals and major corporations. Additionally, the TLD Cards are particularly beneficial for high net-worth individuals whose cash assets are in excess of the individual depositor FDIC insured limit of $100,000. This feature provides very strong incentives to attract high net worth individuals while providing compelling appeal to lower net worth depositors.

### BRIEF DESCRIPTION OF THE DRAWINGS

Fig. A is a chart that describes the entire Trust-Linked Debit Card system in a succinct but all encompassing diagram.

Fig. B is a chart that describes entire Trust-Linked Debit Card system from a slightly different perspective than Fig. A.

Fig. C is a chart that describes how debits and credits can be made to the TLD Card and how the online, phone or PDA Links can be used to transfer balances, pay bills, or invest through a online connection.

Fig. D & E are two charts which should be viewed in relationship to claims N° 23, 25 and 26 below and which illustrates how a non-bank entity can issue debit cards through the issuance of a Master Note & Trust-Linked Debit Card Agreement and the sale of floating note.

Fig. F is a chart which should be viewed in relationship to claims N° 16, 17, 18 and 19 below which illustrates how a homeowner can obtain a loan through the Trust secured by an illiquid asset (e.g. on a home equity) so that the loan proceeds, or any portion thereof, can be invested at a profit. So long as the anticipated rate of return on the investment is greater than the cost of the loan, the profit can be used to accelerate the repayment and ultimate retirement of the first mortgage as well as the loan. In this case a special asset pool of the trust can be created for this class of asset.

FIG. 1 is a chart that explains the steps required to establish multiple Sub-Trusts under a Master Trust within the context of a legal trust structure calling for the execution of a Participation Trust Agreement that protects the deposits of Trust Beneficiaries through the use of unrelated third-party fiduciary agents (the Trustee, the Custodian, the Paying Agent, the asset manager). This Diagram also shows how the legal structure interfaces with the debit card side of the business.

FIG. 2 is a chart that establishes the relationships and functions of all the parties that are necessary to deliver, manage and service the TLD system.

FIG. 3 is a chart that shows how the various account numbers, debit card numbers and bank account numbers interface with each other.

FIG. 4 is a chart that explains the process for a new Trust Beneficiary to establish an account online and to be approved a new customer of a Sub-Trust.

FIG. 5 is a chart that illustrates how databases of separate entities are interfaced in order to deliver the benefits and services required by the TLD Card system.

FIG. 6 is a diagram that explains the use of an account look-up and matching interface that identifies and matches a debit card transaction to the correct account of a Trust Sub-Account Beneficiary (the Cardholder) so as to debit to the Cardholder's account while posting a simultaneously debit and credit (for the same amount) to a bank account that only exists in the bank's database for the purpose of recording and reporting card activities of the Cardholder.

FIG. 7 is a chart that shows how a seamless link can be created to enable an employer to make deposits of employee payrolls directly to each employee's Trust Sub-Account in such a way that amounts so deposited as a credit to the account is immediately available to the account holder/Cardholder for debit transactions via his TLD Card.

FIG. 8 is a chart that Explains the steps required for a new account holder to complete in order to register his investment preferences and his risk tolerance threshold.

FIG. 9 is a chart describes a method of aggregating investment funds between multiple Trusts & Sub-trusts at the Master Trust level, so that account balances can be aggregated and pooled for investment purposes in multiple funds having different investment strategies and objectives.

FIG. 10 is a chart that describes the method of aggregating funds from different Sub-Trusts, where the Sub-Trusts are related to the same Master Trust and where funds can be pooled for investments having varying maturities and different objectives and strategies.

FIG. 11 is a chart that describes the method of distributing investment profits back to the Sub-Trusts through the Master Trust.

FIG. 12 is a chart showing a Trust-Linked Debit Card structure for the Benefit of an Employer and its employees.

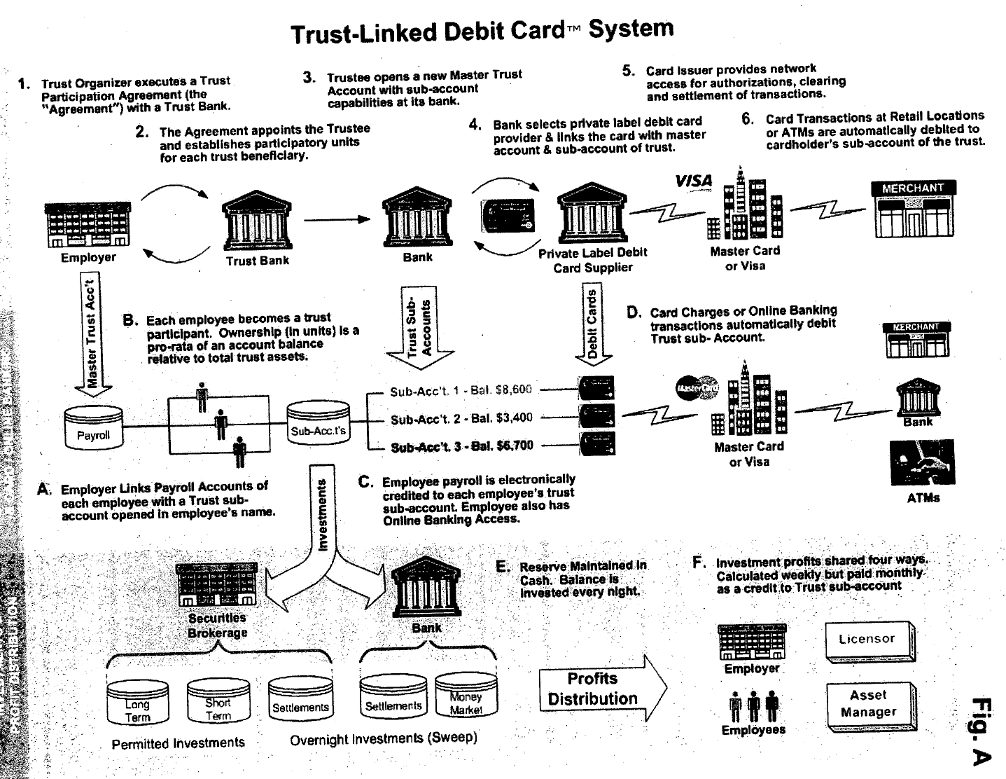

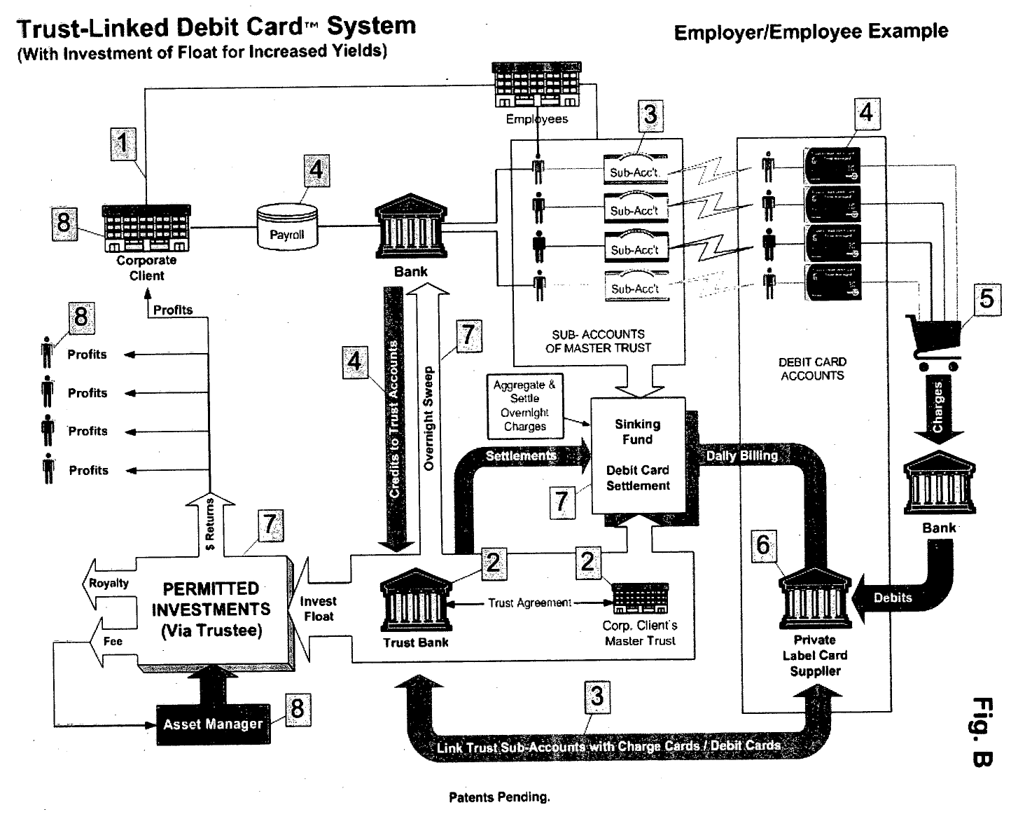

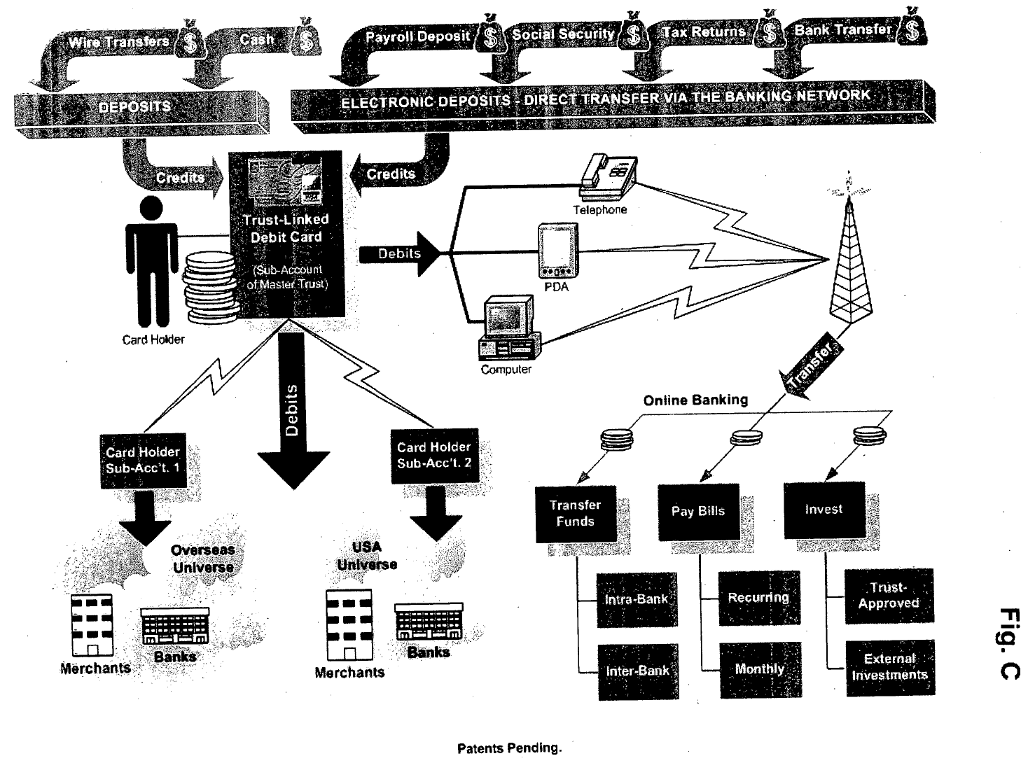

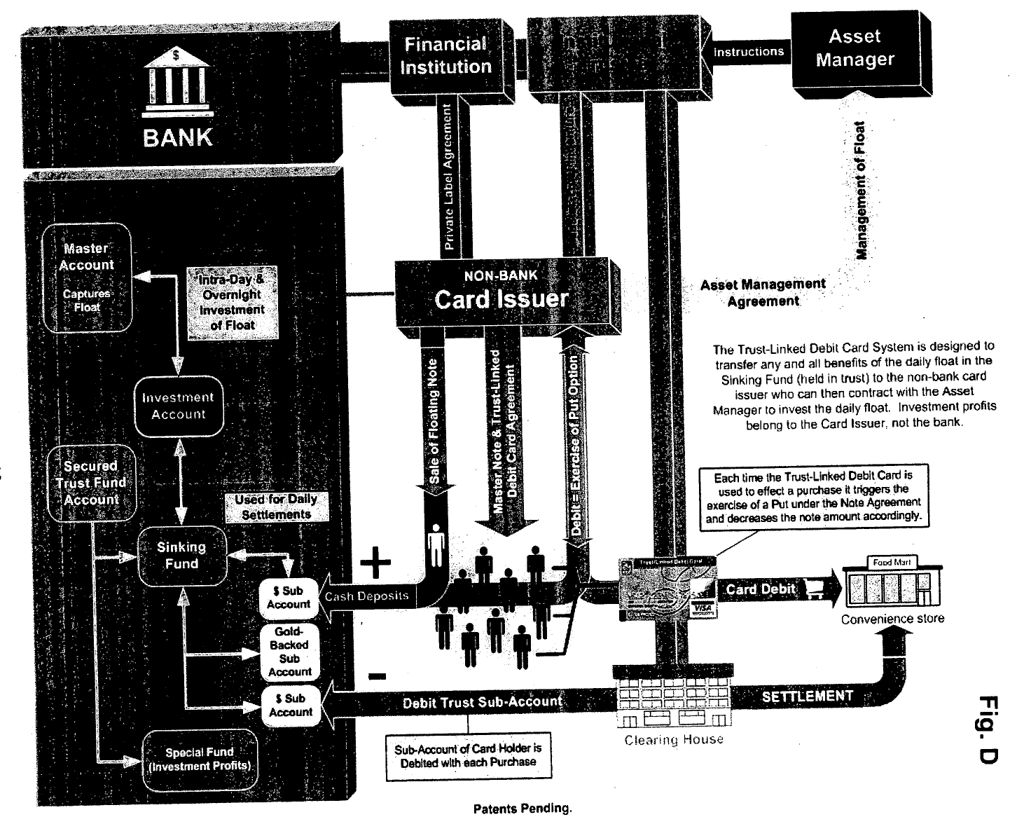

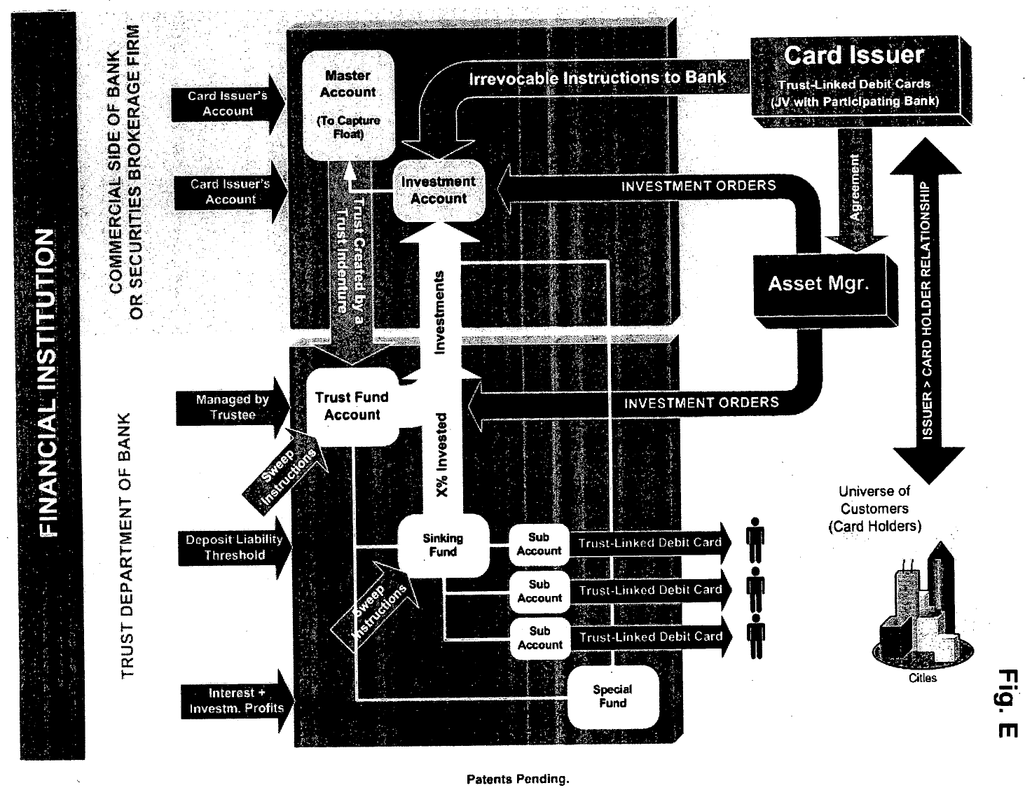

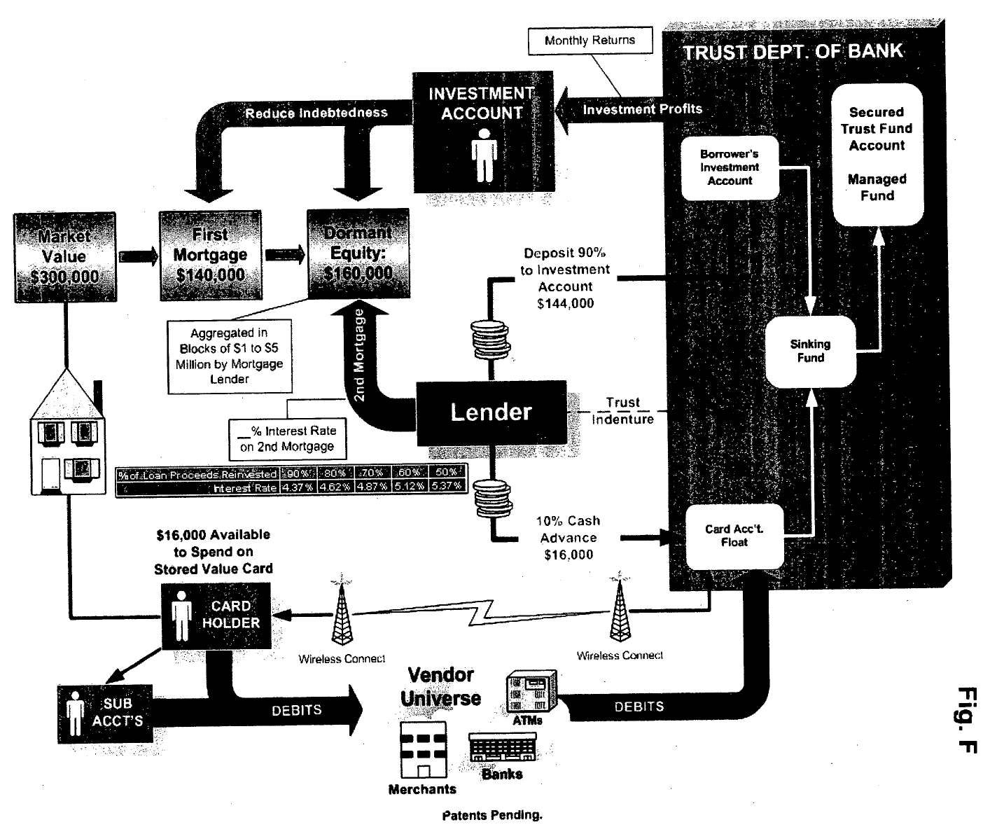

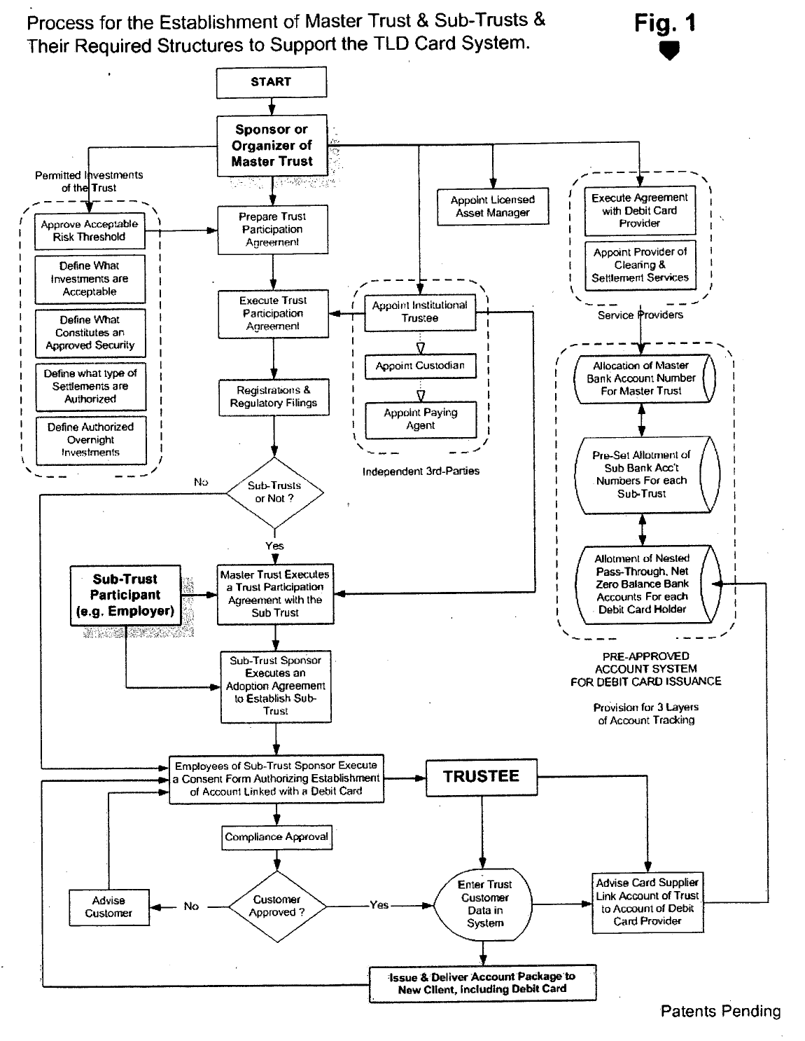

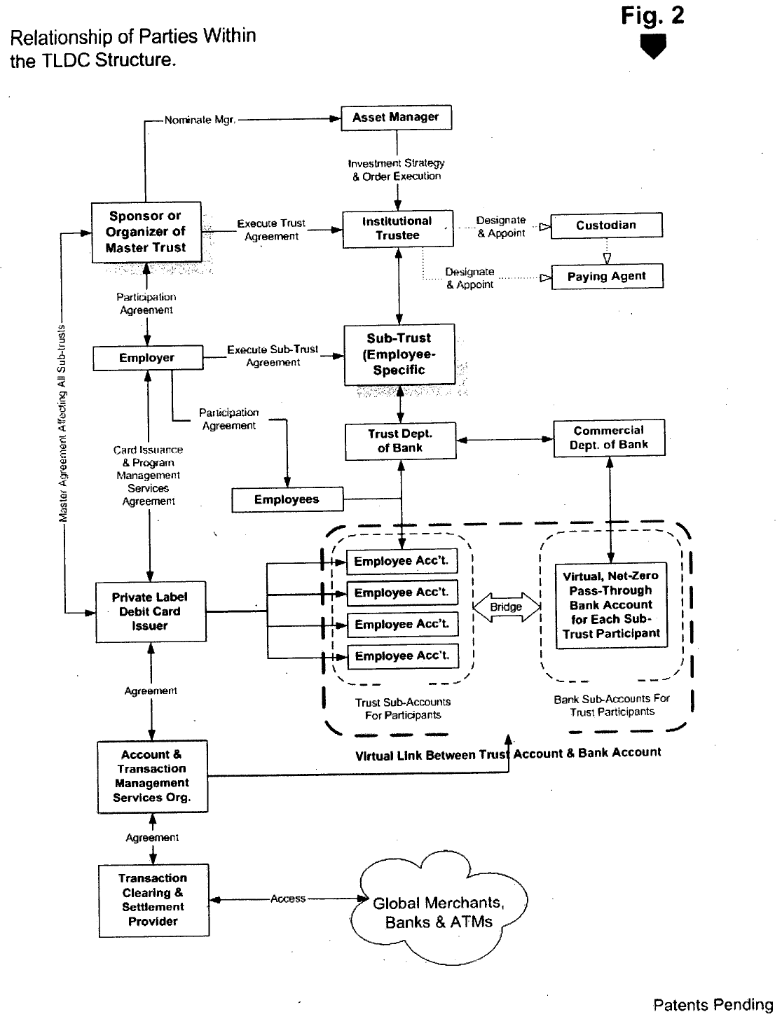

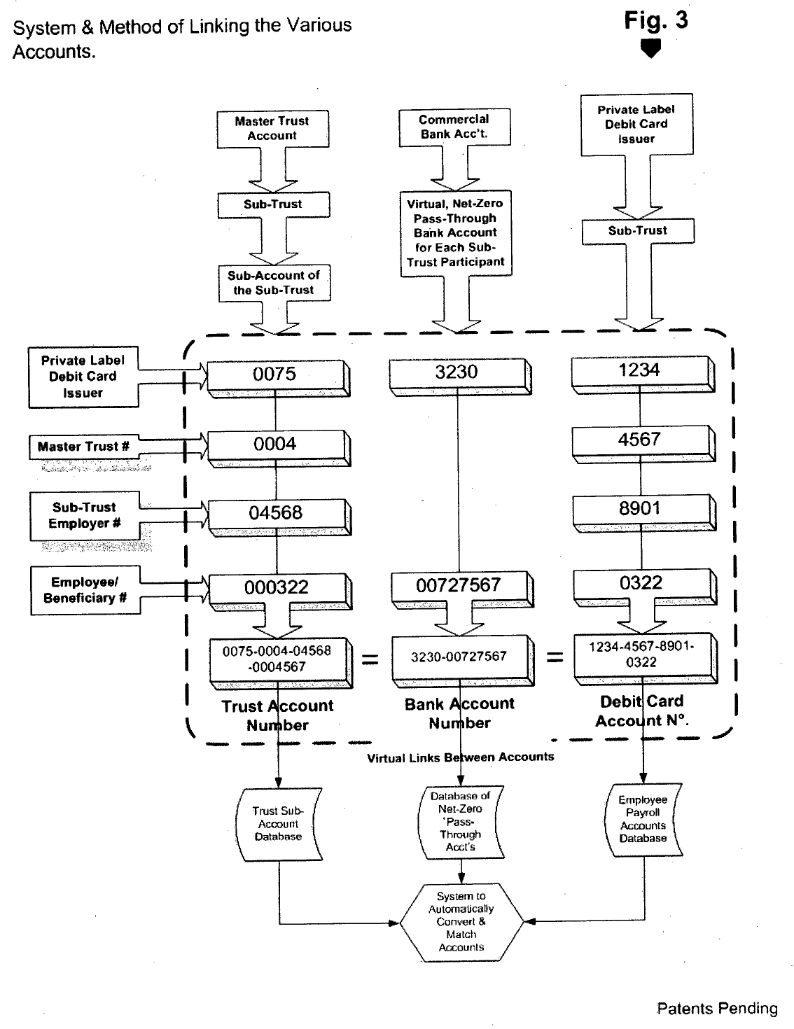

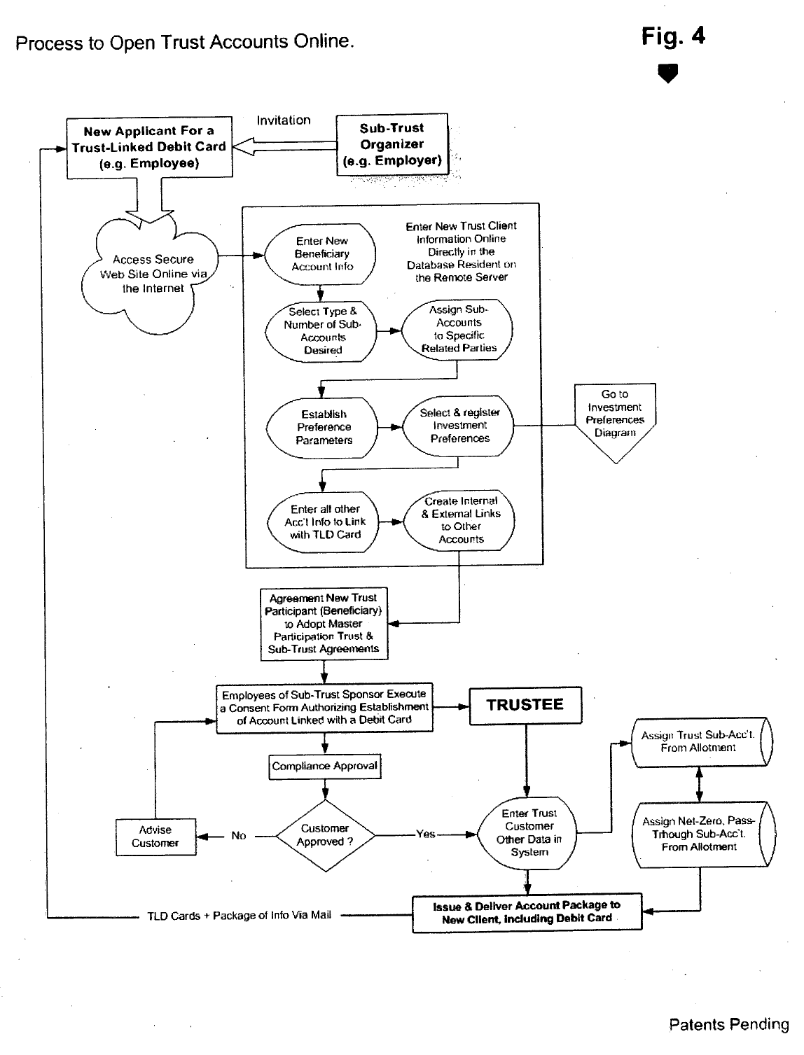

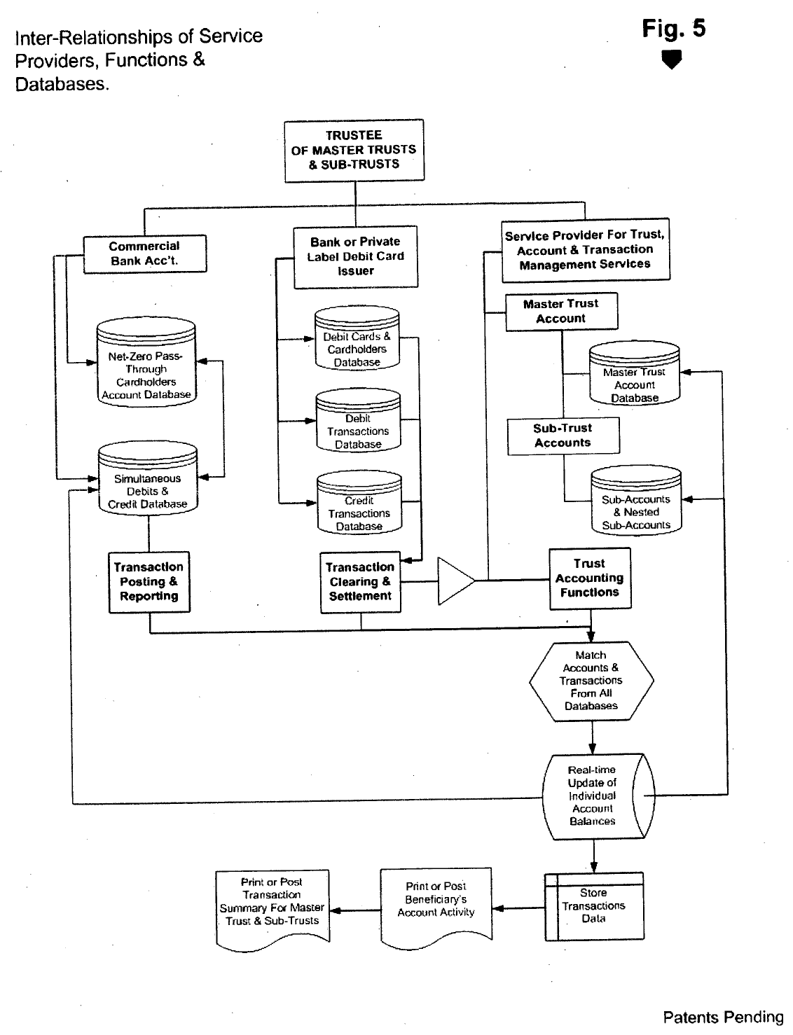

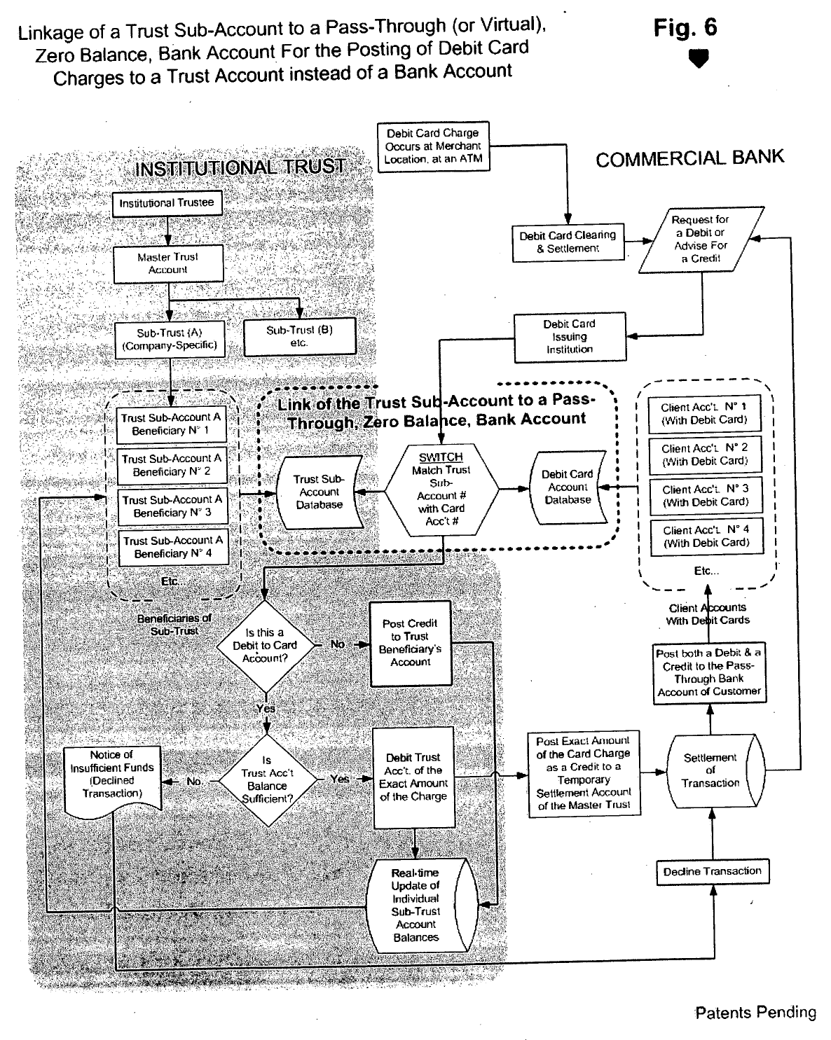

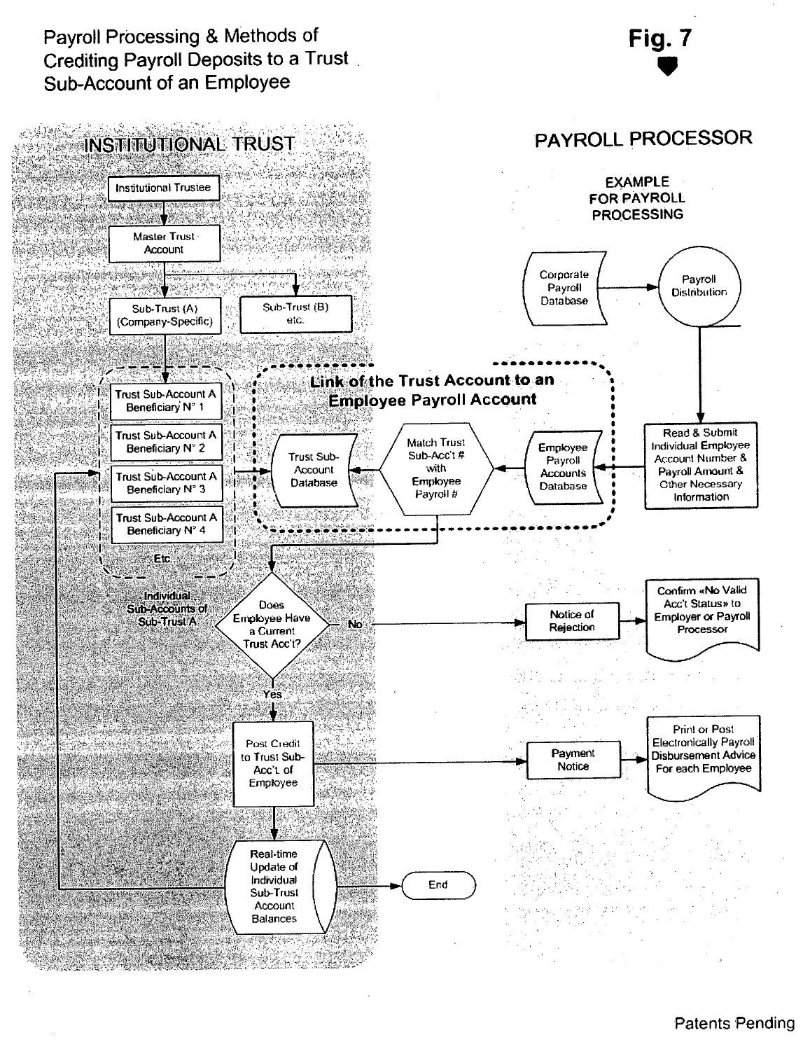

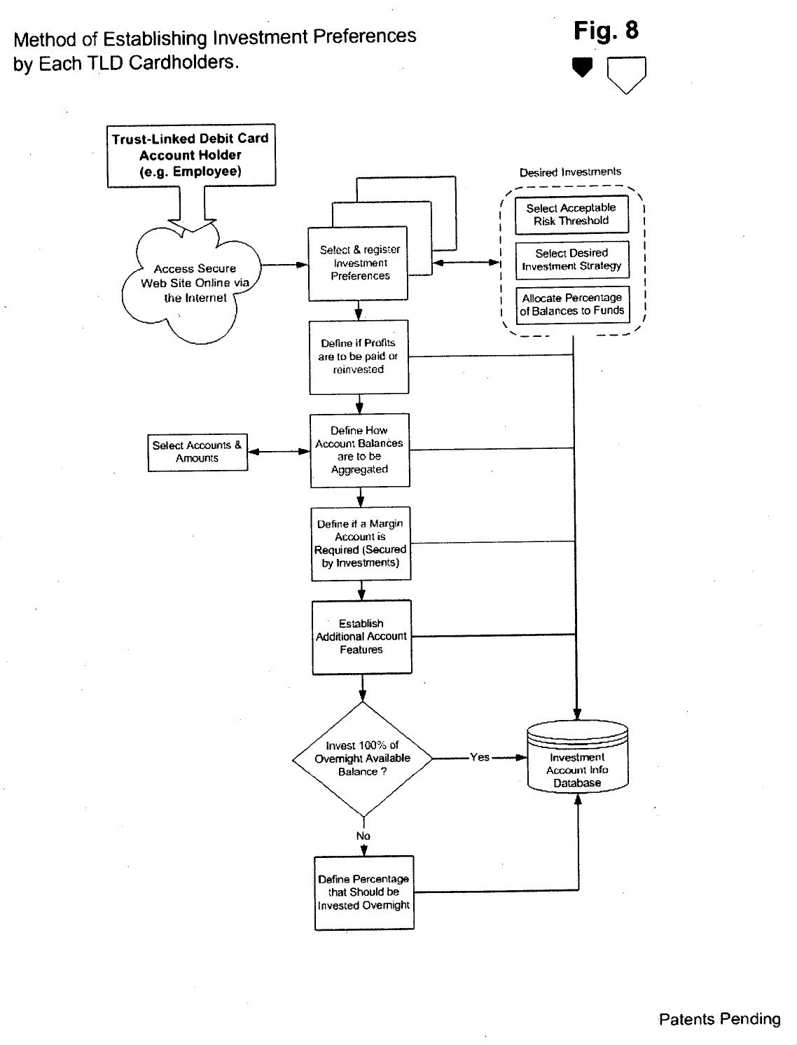

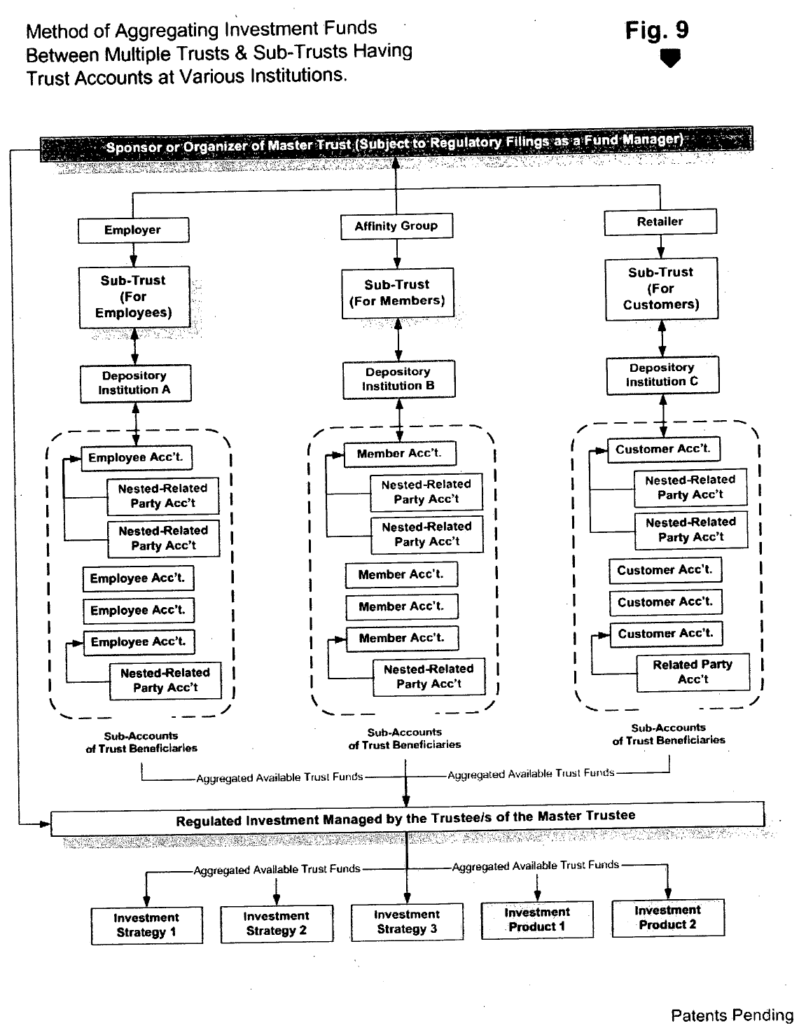

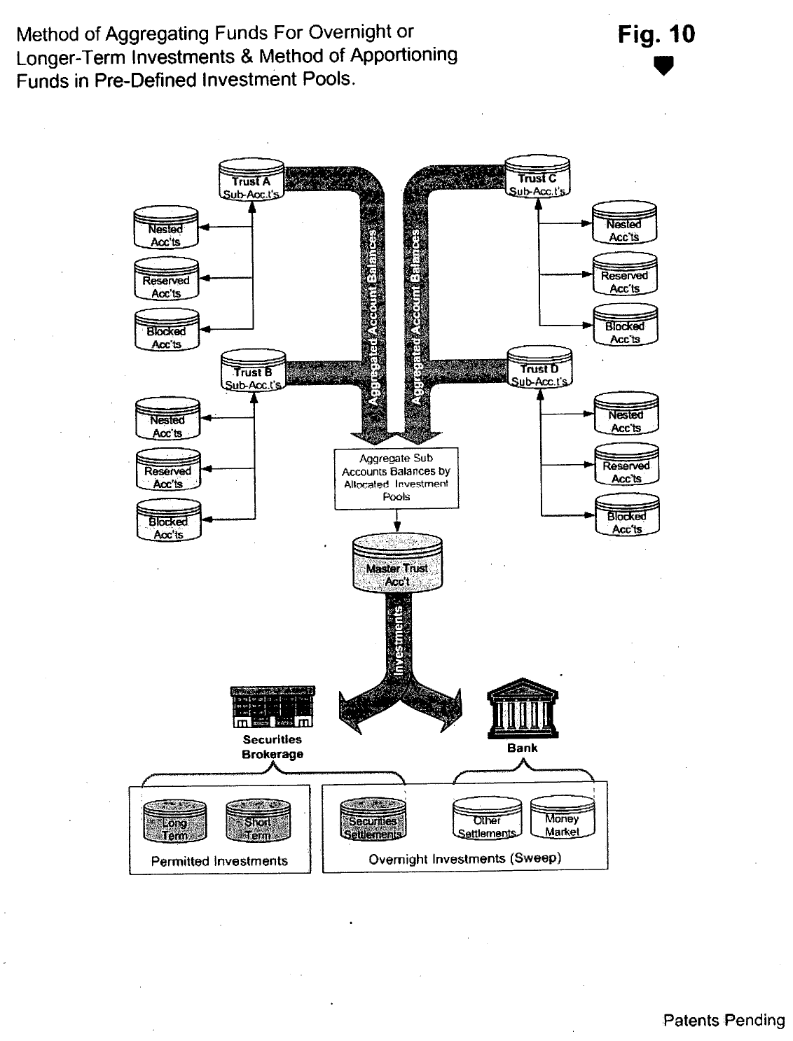

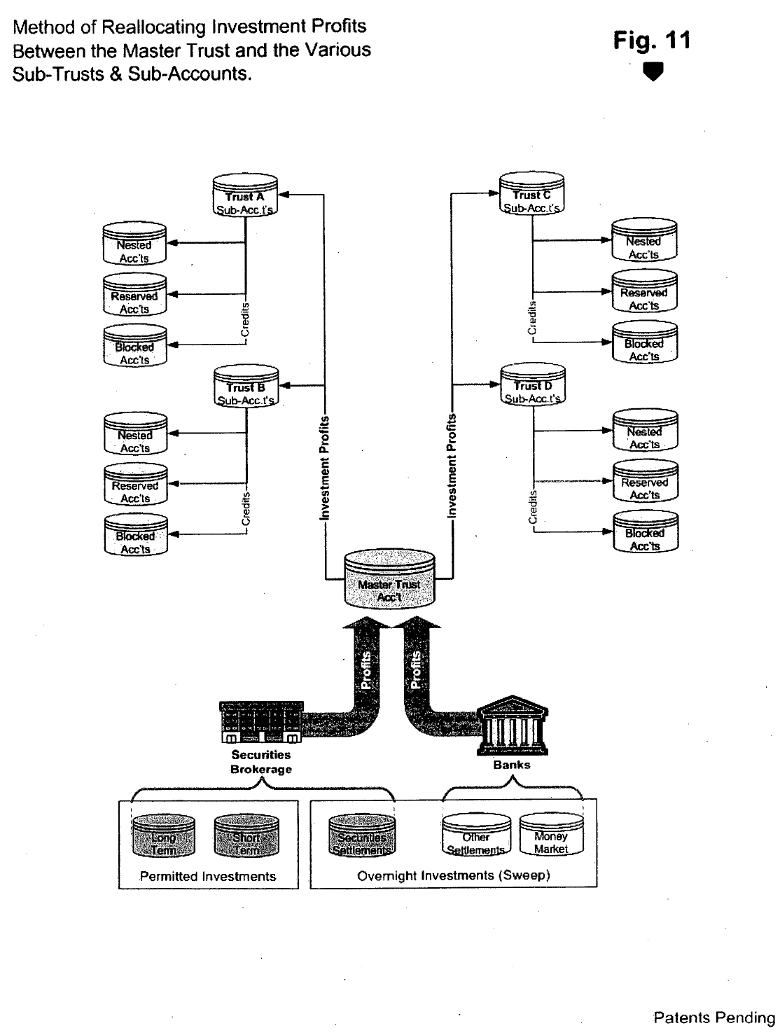

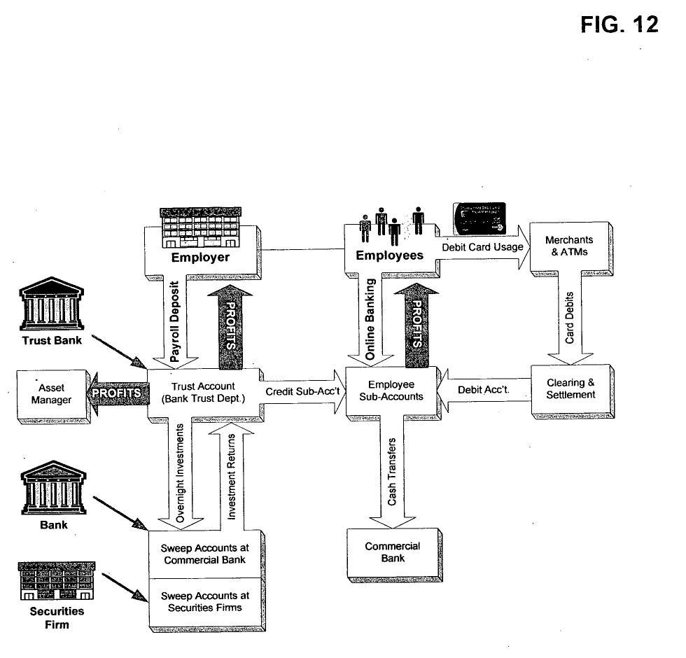

Exhibits A and B are also included, and each include invention disclosure that was present in the above-identified cross-reference to related applications.

### DESCRIPTION OF THE PREFERRED EMBODIMENT

A glossary of the terms used in the present patent application follows.

“Affiliate” means, with respect to any Person, any other Person controlling or controlled by or under common control with such specified Person. For the purposes of this definition, “control” when used with respect to any specified Person means the power to direct the management and policies of such Person, directly or indirectly, whether through the ownership of voting securities, by contract or otherwise; and the terms “controlling” and “controlled” have meanings correlative to the foregoing.

“Available Funds” means the aggregate amount at a particular point in time of cash on deposit in the Sub-Accounts of a Trust which is available for overnight investment by the Trustee.

“Beneficiary” (or a “Trust Participant” in the case of a Participation Trust) is Person who owns a fraction of the Trust Estate as evidenced by Trust-Issued Receipts, Trust Notes or Trust-Participation Receipts, in pro-rata of his total holdings relative to the total Trust Estate.

“Cardholder” means any Person who is the holder of a Trust Sub-Account and who, by virtue of having adopted the Trust Agreement in which he is a beneficiary, has received a Floating Trust Participation Receipt for his initial deposit as well as a debit card that links directly to the Trust Sub-Account of the Cardholder.

“Custodian” means a bank or securities firm that is designated to act as custodian for Available Funds of the Trust and other Trust Funds.

“Distributable Funds” represents: (a) the portion of a Participant's funds on deposit in Participant's Sub-account and earmarked as being the amount (or percentage of total deposits) needed to be available at all times on simple demand (with no notice) to settle daily TLD Card payments or cash withdrawals; or (b) the amount of dividends, interest or profits earned by the Trust and posted to the Sub-account of the Participant. Distributable Trust Funds can be left on deposit in the Trust Sub-account until needed, in which case they continue to earn interest for the Cardholder/Participant.

“Floating Trust-Participation Receipt” is a Trust Participation Receipt that is initially delivered to a Trust Participant to evidence that party's beneficial interest at any point in time in the Trust Estate to the extent of his holdings therein. Since a Participant's account balance in a Trust Sub-Account will fluctuate daily when deposits and withdrawals are posted, the receipt amount evidencing available funds on account is floating as defined in the receipt certificate. Therefore, rather than being for a set receipted amount, such Floating Trust-Participation Receipt, when issued and delivered upon the opening of a Participant's Trust Sub-Account, will establish the method and basis of calculating, booking and reporting the balance of a Sub-Account at any point in time.

“General Investment Guidelines” shall mean the investment of Available Funds in accordance with the investment principles and guidelines defined in the Trust Agreement in the “Permitted Investments” section, the Trust Participation Agreement or the Trust Indenture.

“Instruction/s” means any investment orders issued from time-to-time in writing by third-party Asset Manager and addressed to the Trustee that is a “Permitted Investment” under the Trust Agreement or the Trust Indenture. Such written Instructions, when issued and delivered, obligates the Trustee and/or the Custodian to execute them.

“Invest-able Deposits” represent the portion of a Participant's Sub-account balance that has been earmarked (as a specified amount or as a percentage of total deposits) which the Trust is permitted to invest on the Participant's behalf and where such funds are callable, with some form of advance notice and without penalty, or for a specific pre-determined period.

“Investment Profits” mean the gross profits earned from any and all Permitted Investments of a Trust, less any and all pre-determined and pre-approved investment management expenses.

“Manager” or “Asset Manager” means any person or entity appointed from time to time by the Settlor of a Master Trust or a Sub-Trust to give investment Instructions to the Trustee in accordance with the terms and conditions of a Trust Agreement or a Participation Agreement.

“Master Trust” means a Trust which itself is the sole beneficial owner of 100% of the Trust Estate of other similar trusts.

“Nested Sub-Account” means a nested account of a Trust Sub-Account opened in the name of the principal account Beneficiary but which benefits a Related Party (e.g. employees of a company who use a debit card to automatically debit their travel expenses to the Trust Sub-Account of their employer, children or spouses of a cardholder who use the card, foreign parents of a migrant worker who are in need or support abroad, etc.).

“Non-Cash Contributions” means the contribution made by a Person to the Trust Estate effected by means of a transfer or assignment of all legal rights, title and interest to a specific non-cash asset, in exchange for a Trust Participation Receipt that can only be redeemed at maturity via the return of the original non-asset to the original contributor (e.g. a second mortgage in a residential home or rental property of a Beneficiary, restricted stocks of public corporations, stocks of public companies that fall below the minimum pricing threshold to qualify for a margin facility, etc.).

“Participant” means any Person or Entity that has deposited or caused money to be deposited to a Trust Sub-Account. Such a Participant is also the Beneficiary and the holder of the Trust-Linked Debit Card (the Cardholder).

“Participation Agreement” means any duly executed and delivered Participation Agreement between a Settlor and a Participant to establish the basis of that Person or Entity's relationship to the Trust. It establishes the method of making deposits, withdrawals, and payments, as well as establishing the basis upon which the Person or Entity's beneficial interest in the Available Funds will be booked, profits and dividends accounted for, posted to the Person's account and reported on monthly statements of account.

“Participation Trust” means a statutory Master Trust or a Sub-Trust (normally named: The XYZ Participation Trust) formed by an individual, a company, a non-profit organization, or an affinity group for the ultimate benefit of the intended Beneficiaries. This would include, for example, an employer that contributes a nominal amount to the Trust corpus but intends for the Trust to be operated for the benefit of its employees. In this instance, the employer would be able to automatically cause employee-approved payroll deposits or bonuses to be posted electronically directly to that employee's Trust Sub-Account each month. Each time a deposit is made to the employee's Trust Sub-Accounts a double accounting book-entry is made to post the credit to the Beneficiary's account and to register a debit to cash (the Trust Estate), and to issue a Trust-Participation Receipt in favor of the Beneficiary.

“Permitted Investments” means investments authorized by the Trust Indenture or the Trust Agreement executed by the Trustee pursuant to orders received from a duly authorized Asset Manager and which complies with all investment guidelines including clear definition of an acceptable investment in terms of the type of investment products bought and sold, the duration of any investment, the credit risk, the settlement method, the exit strategy, and the overall risk tolerance.

“Person” means (a) any natural person, (b) any corporation, limited liability company, partnership, trust, joint stock company, unincorporated association, non-profit organization, joint venture or other entity established to conduct business or (c) any federal, national, state, provincial, municipal, local, territorial or other governmental department, commission, board, bureau, agency, regulatory authority, instrumentality or judicial or administrative body, whether domestic or foreign.

“Registrar” means an institution duly appointed to perform all accounting functions for the Trust and to report monthly the account activity for each Participant.

“Related Person” means any Person who is a related family member, a trustee, or an attorney-in-fact of such Person.

“Settlor” (also known as the Creator or Grantor) is the person or entity that enters into an agreement with a Trustee to form a new Trust.

“Sub-Trust” means a Trust whose Trust Estate is entirely owned by a Master Trust. In the case of the TLD Card System, Sub-Trusts can be individual Trusts formed for the purpose of accommodating specific organizations desiring to issue branded Trust-Linked Debit Cards (e.g. employers, retailers, banks & financial institutions, affinity groups, credit unions, etc. desiring to offer the benefits of a TLD Card to their employees, members, customers or clients).

“Trust” in law means a legally-created fiduciary relationship in which a qualified person or legal entity (one free of conflict of interest) called a “Trustee” holds title to property for the benefit of one or more Persons, called a “Beneficiary” or “Beneficiaries”. The agreement that establishes the Trust, contains its provisions, and sets forth the powers of the Trustee is called the Trust Agreement or the Trust Indenture. The person or entity creating the Trust is the Creator, Settlor, Grantor or Donor; the property itself is called the “corpus”, the “Trust Funds” or the “Trust Estate” which is distinguished from any income earned by it.

“Trust Account” means a bank account or Trust account of a Master Trust or a Sub-Trust.

“Trust Sub-Account” means the sub-account of a Trust Account normally opened in the name of an individual Beneficiary or Participant.

“Trust-Issued Receipt” is a Trust receipt issued by the Trustee of the Trust in favor of a Beneficiary to evidence the Beneficiary's pro-rata beneficial ownership in the Trust corpus up to the amount shown on the receipt. A Trust-issued receipt operates much like a stock certificate of a corporation with the main difference being that in the case of a Trust, the assets of the Trust are managed by an independent Trustee in accordance with the pre-defined terms and conditions of the agreement governing the Trust.

“Trust-Participation Receipt” is a receipt issued by the Trust in favor of a Participant, that operates much like the Trust-issued Receipt, except that it is issued in favor of a non-related third-party that causes deposits to be made to a Sub-account opened in the Participant's name under the master account of the Trust in accordance with the terms and conditions of a “Trust Participation Agreement,” thereby causing the Participant to be de-facto a Beneficiary of the Trust to the extent of the Participant's holdings in the Trust.

“Trust-Linked Debit Card” is a term used to describe the debit card product which is the subject of this invention.

“Trust Company” means a regulated and licensed organization usually combined with a commercial bank, which is engaged as Trustee, fiduciary or agent for individuals or businesses in the administration of Trust funds, estates, custodial arrangements and other related services.

“Trust Estate” means all rights, title and interests the Trust has in the aggregate of all cash deposits of Beneficiaries to their Trust Sub-Accounts at any point in time calculated as the total of all assets less the total of all liabilities, including set-aside reserves that are subject to a fiduciary duty of the Trustee. It is also the amount that is normally available for investment purposes, and it includes any and all accumulated and accrued interest, dividends or profits earned by the Trust as well as any other asset otherwise acquired by the Trust.

“Trust Funds” means the aggregate of all cash funds and other assets deposited to the credit of the Trust by the Settlor, Grantor, Beneficiaries or Participants.

“Trust Indenture” is a legal agreement that establishes the Trust and appoints a Trustee to manage the assets of the Trust. It is an agreement entered into between a Settlor and a qualified Trustee which normally contain protective clauses for bond holders or Beneficiaries, including how funds are to be managed. Its provisions set forth the powers of the Trustee and establish the interest of the Beneficiaries or Participants in the assets held in Trust.

“Trust Note” is a debt instrument that obligates the Trust to pay the holder of the note the principal and interest, if any, when due, in accordance with the terms of the Note. A Trust can create an indebtedness secured by Trust Assets, unless such activity is specifically prohibited by the Trust Agreement.

“Trustee” is a qualified (meaning free of a conflict of interest) person or legal entity, such as a Trust Company that holds title to property for the benefit of one or more Persons, called a “Beneficiary” or “Beneficiaries”. A Trustee is usually charged with investing Trust property productively for and on behalf of the Beneficiaries in accordance with the specific instructions of the Trust Agreement or Trust Indenture. The Trust Agreement will usually define whether the Trustee can make investment decisions of his own or whether he is only to execute investment orders submitted by a third-party asset manager.

Turning now to the details of the invention, the Technology generally includes a system or method to enable a Person to:
(a) Open a Trust Sub-Account in their name by making an initial deposit to a Sub-account of the Trust corpus.
(b) Obtain one or more TLD Cards in the Person's name as well as any number of additional cards issued in the name of an Affiliate or a Related Person.
(c) Entirely manage the Trust Sub-Account as well as the nested sub-account online via the Internet or via phone links to the central server.
(d) Create an unlimited number of seamless links online via the Internet between the Trust Sub-Account, the nested sub-accounts and any number and type of internal or external accounts, including, but not limited to, demand bank deposit accounts, savings accounts, mutual fund accounts, brokerage accounts, etc.
(e) Access the Sub-account online to create an unlimited number of seamless links between the Trust Sub-Account and any number of Nested sub-accounts opened in the name of Affiliates or Related Parties (e.g. to automatically transfer pre-set amounts to children who are at college or to overseas family members who need monthly support),
(f) Obtain one or more TLD Cards which, when used at an ATM or a merchant location will simultaneously cause: (i) a debit to be posted directly to the Trust Sub-Account of the Cardholder or one of the Nested Sub-Account, (ii) a credit to be posted to a temporary merchant settlement account, and (iii) post both a credit and a debit to a “pass-through, net-zero bank checking account”
(g) Receive automatic fund transfers into the Cardholder's account (e.g. payroll deposits, social security checks, alimony payments, etc.)
(h) Program the Sub-account to make automatic recurring payments to pay bills.
(i) Define how much of the account balance, as a fixed amount or as a percentage of available cash, that can be invested and how much should be maintained at all times in a Sinking Fund used to settle debit transactions.
(j) Have 24/7 access to their funds through the TLD Card
(k) Invest funds into a variety of customer-directed pre-defined investment strategies (e.g. money market funds, repo and reverse repo, etc. . . . )
(l) Earn significant dividends on account balances that would normally produce little or no interest. Available Funds of the Trust can be invested in Permitted Investments and the profits derived from such investments can be distributed to Cardholders.

The Technology requires the following hardware, software, user interface features (which may also be thought of as seamless) and systems:
I. A hardware and software platform to run and manage the Trust-Linked Debit Card System (“TLD Card”), including the Trusts, the Trust Sub-Accounts and the Nested Accounts of the Sub-Accounts as well as all the account management functions for online transaction processing and banking.
II. An integrated software system to allow Cardholders to:
   a. View transaction history, current balances, fee schedules, returns from investments
   b. Complete online banking transactions and orders from a secure website.
   c. Select desired investment options, the amount that can be invested overnight and the amounts to be maintained in cash at all times.
   d. View and analyze investment returns over time.
   e. Open and manage Sub-Accounts and Nested Sub-Accounts for Related Parties.
   f. Link the primary Trust Sub-account to any number of other bank accounts, checking accounts, savings accounts, investment accounts, etc. whether within the same financial institution or not.
III. A software system to manage the investment of the Available Funds including the calculation and posting of daily Trust dividends to individual Cardholders accounts and the reporting of same at month-end.
IV. An integrated software system to allow customer service representatives of each Master Trust and Sub-Trust programs to view and support:
   a. Data entry for each Master Trust & Sub-Trust marketing program, including data entry screens for input of each program (Trustee and Beneficiary information, contracted program terms and conditions, approved investments and risk tolerance thresholds, profit-sharing percentages and distribution of investment proceeds, etc.).
   b. Individual Cardholder transaction history and current balance information.
   c. Investment transactions undertaken by the Trustee on behalf of Sub-Trust account holders and the returns attributable to each Cardholder in pro-rata of total investment returns.
   d. Posting and reporting of investment returns for each Trust and Sub-Trust and daily or weekly postings to Cardholders' accounts.
   e. Posting of adjusting entries.
V. A software system to seamlessly interface and bridge the TLD Card Technology with the global transaction processing backbone or platform used to process transactions (e.g. the VISA or Master Card Systems or any other similar global transaction processing, clearing and settlement network) (hereinafter the “Transaction Processing Backbone” or “TPB”).
VI. A software system to facilitate the seamless exchange of messages, transaction data and values between the respective systems and platforms.
VII. A software system to automatically receive and credit payroll deposits to a Cardholder's account and to simultaneously transmit a phone messaging text to the Cardholder confirming the payroll deposit to the Cardholder's Sub-account.
VIII. A software system to automatically interface with a cellular phone system designed to send and receive text messages that inform the Cardholder of usage or attempted usage and allows accounts to be activated or deactivated at a distance through instructions executed via the phone system.
IX. A software System to seamlessly integrate TLD Card-originated transactions with a TPB-approved and TPB-supported system and technology designed to deliver the following features:
   a. Full online banking capabilities.
   b. Cash withdrawal at any TPB supported ATM worldwide.
   c. Balance inquiry from an account at a TPB supported ATM.
   d. Worldwide authorization, clearing and settlement of a purchase transaction emanating from an account at a TPB-supported merchant location via the TPB system.
   e. Complete processing of debit and credit operations between the cardholder's Trust Sub-Account and the net-zero, pass-through bank account.
X. An integrated software system to support, amongst other things, the following functions:
   a. Customer service access, programs, distributions, payees, and assignment of card account number ranges to Master Trusts and Sub-Trust-originated programs.
   b. Management, via a secure website, of individual “marketing programs” developed for the various Sub-Trusts, financial institutions, employer groups, affinity groups, etc., and their respective product offerings to their trust beneficiaries.
   c. Use of cell phone to transfer funds seamlessly and instantly from one account to another account.
   d. Instantaneous and secure high-value transaction validation and authorization via cell phone.
   e. Instantaneous fraud prevention activation process through the use of a cell phone.
   f. The seamless creation of program-specific fee distribution tables.
   g. Automatic calculation, distribution and posting of daily debit and credit transactions to support each Sub-Trust investment functions and daily postings and reporting functions.
   h. Distribution of investment proceeds earned by each Trust and posting of distributable Trust dividends to cardholders' Trust Sub-Accounts.
   i. Calculation and posting of payments due Trustees, asset managers, custodians, paying agents, employers, sponsors and marketing agents, etc.
XI. System to support the transfer of cash from the sub-trust card holder's account to a prepaid debit card usable worldwide on the TPB system completely independently from the TLD Card system and the loading of funds on such prepaid debit cards as provided by the financial institution. This feature may be used for instance by foreign workers who want a prepaid card to be instantly available.
XII. System to generate top-level, master trust, sub-trust, and card-holder level reporting from its transaction and investment management database via a secure website for cardholders, customer service representatives, trustees, asset managers, licensees, and licensee's financial institutions.

Turning now to an alternate way of characterizing the invention, the following numbered paragraphs are provided with the above description.

1. A system or method that enables non-banking (e.g. an employer, a retailer, a mutual fund, a non-profit entity, etc.) to cause the issuance of a trust-linked debit card (e.g. a debit card issued by a private label card provider/TPB System provider) for profit, without being subjected to the same compliance, regulatory, reporting and auditing constraints that banks are.

2. A system or method that builds on a “Participation Trust” structure as the legal framework used to aggregate multiple individuals, corporate and non-profit organizations funds that can then be invested by the Trustee in “Permitted Investment” in accordance with the Trust Agreement.

3. A system and method to facilitate the aggregation of overnight balances of multiple small depositors into a large investment pool that can be invested daily for profit in higher yielding products and strategies (e.g. repo and reverse repo) that are normally only and exclusively available to ultra high net-worth clients and corporations through the private banking side of the banks.

4. A system or method that aggregates account balances of multiple small depositors through a process that causes consumers and businesses alike to become fractional beneficial owners of a Participation Trust to the extent of their deposits relative to total Trust Estate so that each participant in the Trust will be sheltered from the risk of banks' insolvency for deposit amounts over and above the regulated bank-insured limit. Since trust funds are not considered as an asset of the bank (the trustee acts as a fiduciary in this case), it therefore cannot book trust funds as an asset of the bank on its balance sheet.

5. A system or method that creates an incentive and a reason for banks, financial institutions, insurance companies, brokerage firms and managed funds to compete for the overnight deposit business of the Trust by offering returns and strategies that have heretofore only been reserved for wealthy private banking that is likely to result in a higher than normal rate of return on invested capital.

6. A system or method that causes multiple trusts to be formed in cascades (Master Trusts & Sub-trusts) so that funds available for overnight investments can be aggregated for investment purposes into one or more mega funds that will be invested in multiple strategies and products designed to yield above-average returns for the Beneficiaries of the Trust.

7. A system or method that delivers to individuals, small business owners, corporations, affinity groups and non profit organizations, a profitable, higher-yielding alternative to traditional checking and savings accounts that require high minimum balances for free-checking and for which little or no interest is offered or paid by the banks since such accounts are often looked upon by the bank executives as “free money”.

8. A system and method that allows expatriate and/or migrant workers worldwide to support dependent family members and relatives in their home country while saving on the high cost of transferring and converting money abroad and eliminating the time-consuming burden it creates for both sender and receiver.

9. A system and method that allows Cardholders to support dependent family members (e.g. college students, aging parents, alimony recipients) or by providing each Related Party a Trust-Linked Debit Card linked to a Nested Sub-Account that they can use to withdraw cash or make purchases up to the pre-authorized sub-account balance limit.

10. A system and method that allows businesses to provide for traveling employee expenses through the issuance of a Trust-Linked Debit Card that causes debits to be posted to a Nested Sub-Account they can use to withdraw cash or make purchases up to the pre-authorized sub-account balance limit.

11. A system and method that allows business owners or managers to immediately post a credit to the sub-account of a traveling employee to meet unexpected or emergency needs and where such posting is immediately credited to the account of the cardholder and therefore available for expenses.

12. A system and method that allows employers to create their own sub-trust designed to enhance employee benefits or facilitate the automatic distribution and posting of payroll deposits, commission and/or bonus deposits, directly to the Beneficiary's Trust Sub-Account and/or for the purpose of enhancing employee benefits through the issuance of a Trust-Linked Debit Card to each employee to which the employer can add its own employee benefit package and features.

13. A system and method that allows cardholders to manage their account and investments online via a secure web-based connection to maximize returns on the daily available float.

14. A system and method that establishes a trust relationship between a fiduciary (the Trustee) and a single or multiple trust beneficiaries whereby representations can be made by the Trustee to a single or multiple independent third-parties that funds are on deposit and are available for transfer or are blocked or reserved for a particular transaction for a pre-set period of time or for an indefinite period of time until a pre-defined event occurs and which time funds are released by the fiduciary in favor of the counterparty. The following examples are only offered to illustrate the practical applications of the technology, but are in no way limiting as to such actual applications:
a. An Auction Participation Trust (APT) (or Sub-Trust) in which funds of high net worth individuals may be deposited in a Trust sub-account as proof of funds for use in bidding on high value items at auction while earning above market yields up and until the actual auction.
b. A Home Equity Loan Participation Trust (HELPT) in which funds from both small and large home equity loans may be deposited in a Trust Sub-Account and segregated in such a way that some funds immediately are available to the account Beneficiary for normal ATM and merchant transactions while a pre-agreed percentage is held in reserve for long-terms investment in strategies that are designed to deliver above-average market yield that can then be used to pay down first and second mortgage balances.
c. A Real Estate Deposit Participation Trust (REDPT) in which refundable deposits required for commercial, industrial, retail, and residential real estate leases are deposited in Trust sub-accounts pending an escrow closing so that available funds can be invested to earn above market yields as long as the lease requires the deposit to be held.
d. A Commercial Equipment Lease Deposit Participation Trust (CELPT) in which deposits required for an equipment lease (to protect the Lessor by offsetting losses due to: unreasonable wear and tear to returned equipment; the non-return of equipment; or any other costs incurred due to the Lessee's actions) are deposited in Trust sub-accounts and will earn the equipment lessees above market yields when there are no losses experienced by the Lessor during the lease term.
e. A College Savings Plan Participation Trust (CSPPT) in which funds for College Savings Programs [Internal Revenue Code Section 529 (26 U.S.C. 529)] are deposited in Trust sub-accounts and earn above market yields without the risk associated with other investments, increasing the “value” of earnings that are federally tax exempt.
f. A Brokerage Cash Participation Trust (BCPT) in which funds of individual clients and institutions held by brokerage firms and not invested in stocks, bonds, and other investment vehicles are deposited in Trust sub-accounts to earn higher yields than those associated with money market funds.
g. A Retirement Fund Participation Trust (RFPT) in which funds contributed by employers and individuals to 401K, IRA, and Roth IRA accounts are deposited in Trust sub-accounts to earn higher yields than those associated with money market funds, prior to investment in equities, bonds, and other investment vehicles.
h. An Endowment Fund Participation Trust (EFPT) in which endowment fund balances are deposited in Trust sub-accounts to earn higher yields than those associated with money market funds, prior to investment in equities, bonds, and other investment vehicles.
i. A Probate Funds Participation Trust (PFPT) in which Probate fund balances, and funds from the sale of property and other estate assets, are deposited in Trust sub-accounts to earn higher yields than those associated with money market funds prior to distribution to an estate's beneficiaries.
j. An Escrow Participation Trust (EPT) in which escrow funds deposited to “secure” a transaction are deposited in Trust sub-accounts to earn higher yields than those associated with money market funds, and in which the investment return on the escrow funds are disbursed to the depositor at the same time the escrow funds are distributed to the transaction beneficiary.
k. A Health Savings Participation Trust (HSPT) in which employer contributions to health saving accounts (HSAs) are deposited in Trust sub-accounts to earn higher yields than those associated with regular deposit accounts and money market funds.

15. A system and method where funds on deposit in the Trust Sub-Account of a Beneficiary can be “blocked” or “reserved” by the Trustee (debit the Beneficiary's account and credit a suspense fiduciary account of the Trust) for a particular event involving at least two counterparties in which the Beneficiary is the originator of the written order to initiate a particular transaction or event (e.g. to evidence cash funds on deposit to open access to public or private bidding, as is often the case for high value items or property).

16. A system and method where Non-Cash Contributions can be made to the Trust Estate by individual Beneficiaries (e.g. a real estate property, a second mortgage, etc.) so that such asset can be used to secure a cash loan that can then be invested by the Trust solely for the benefit of Beneficiaries who have contributed like assets.

17. A system and method where Non-Cash Contributions to the Trust Estate can be aggregated into pools of like-kind assets for the purpose of securing a loan for the benefit of the Trust in such instances where the investment rate is expected to be greater than the interest cost of the loan.

18. A system and method where non-cash assets of the Trust Estate can be pledged as security for a loan, a line of credit or simply used to secure the issuance of Trust Notes (rated or non-rated) that are subject to a Trust Indenture and where the proceeds thereof can be invested strictly for the benefit of that class of Beneficiaries (non-cash contributors) of the Trust.

19. A system and method where cash and non-cash contributions of Beneficiaries can be segregated through a transfer from one of more primary accounts to one or more nested sub-accounts, where each account balance is reported separately on the monthly statement of the primary account, and where such segregated accounts are the subject of a different pre-defined treatment with respect of the investment of available balances and/or the cash balance immediately available and usable by the Beneficiary of the primary account for debit card transactions at merchant locations or at ATM locations.

20. A system and method where a fiduciary escrow/settlement service (as is the case in an escrow closing) can be provided by the Trustee to facilitate the closing of a transaction between two non-related Beneficiaries of a Trust having a common Trustee and where such closing involve: (a) the blocking of funds (through a reserve set-aside to a suspense account of the Trust) occurs on the first account, and (b) the blocked funds are automatically credited to the account of the second party upon the fulfillment of all the pre-established conditions of the closing.

21. A system or method in accordance with paragraph 1 wherein such financial product consist of a Trust-linked debit card, a regular bank debit card, a stored value card, a credit card, a gift card, or any other similar method of debiting a card account for transactions occurring at a different location than where the account balance is maintained.

22. A system or method in accordance with paragraph 1 where banking-related services are provided for profit or not for profit.

23. A system or method in accordance with paragraph 2 where the legal structure or framework used to: (a) legally support the solicitation and/or the receipt of cash into a Person's account; (b) the issuance and delivery of a debit or credit card linked to that account, and (c) the investment of the account balance, is based on a trust arrangement that uses a fiduciary, Trustee, custodian, asset manager, fund advisor, fund manager or any other form of financial advisory service or bank trust services, or where the legal structure used to attract such funds uses any form of structured finance arrangement, including the issuance of corporate notes, floating balance notes, or any other form of linking a trust or custodial arrangement with the issuance and delivery of a card or other form of paying for merchandise or obtaining cash at off-location premises.

24. A system or method in accordance with paragraph 2 where the features of a debit card are coupled (seamlessly linked) with the credit benefits offered by traditional credit cards or with a credit facility where the cumulative resulting benefit is similar to the TLD Card system herein.

25. A system or method in accordance with paragraph 2 and 4 where instead of a Participation Trust used as the legal framework to support the TLD Card system, a company or trust issues a secured or unsecured corporate note in favor of a Cardholder in exchange for one or more cash deposit/s and where the principal outstanding balance due on the note is a floating amount at any point in time calculated as the total of all deposits, less the total of all withdrawals on the account.

26. A system or method in accordance with paragraphs 2, 4 and 25, where the note so issued by the note issuer in favor of the note holder contains a put feature, where the “put” option is exercisable by the note holder (the Cardholder) at any time, for any amount up to the total account balance (floating balance) at that moment in time, on simple demand and without notice, in one or more withdrawals, and whether such put option is exercised through physical walk-in to the offices of the note issuer or through the single or multiple use of the TLD Card (e.g. to post a debit via a withdrawal of cash at an ATM location) to reduce the amount of the issuer's indebtedness due under the note.

27. A system or method in accordance with paragraph 3 which comprises the aggregation of multiple account balances into any number and type of investment pools or funds for the purpose of investing each such pooled balances in overnight or longer term investment strategies designed to yield a profit to the investor.

28. A system or method in accordance with paragraph 1, 2 and 4 that calls for a different legal framework to accomplish the same objective and end result achieved through the use of a Participation Trust structure (e.g. the use of a structured finance approach involving a special purpose bankruptcy-remote company that issues and sells floating principal notes to depositors), and whether or not such other structure encompasses an element of sheltering and/or protecting a depositor against the risk of bank insolvencies.

29. A system or method in accordance with paragraph 5 where available funds are invested directly or indirectly by the Trustee in investment strategies involving overnight or longer investments.

30. A system or method in accordance with paragraph 5 where the aggregated Available Funds of the Trust are swept overnight or at any other pre-defined intervals to the investment service provider's account for investment on behalf of the Trust in repo (repurchase of securities) and reverse repo (loans secured by securities) strategies and/or any other form of investment permitted under the Trust Agreement or the Trust Indenture.

31. A system or method in accordance with paragraph 8 wherein the family members of expatriate and/or migrant workers are the holders of a Trust-Linked Debit Card that is linked instead to a nested sub-account of the primary Beneficiary's account so that overseas family members can cash money at ATM machines or make purchases at retail locations, and where such debits are automatically posted to the nested sub-account of the primary Beneficiary's account.

32. A system or method in accordance with paragraphs 8, 9, 10 or 11 whereby the primary Beneficiary's account can be manually or automatically debited monthly or at any other pre-set intervals, for a fixed or variable amount, through recurring instructions that debit the primary Beneficiary's account and simultaneously credits it to the nested sub-account to replenish it or extend its credit balance.

33. A system or method in accordance with paragraph 12 wherein payroll deposits can automatically be transferred in whole or in part to another account within the same Trust or to any number of external accounts of the Employee/Beneficiary.

34. A system or method in accordance with paragraph 12 wherein payroll deposits can automatically be segregated for savings and/or investment purposes and/or transferred internally to another account within the Trust or to any number of external accounts of the Employee/Beneficiary (e.g. automatic transfers to health savings accounts, etc.).

35. A system or method in accordance with paragraph 12 wherein employers can automatically reimburse employees for travel expenses and any other reimbursable expenses and/or where payroll deposits involves fixed or variable amounts, commissions, bonuses, etc.

36. A system or method in accordance with paragraph 13, wherein Beneficiary's accounts are accessed personally at the institution or through any other electronic form of accessing an account over the Internet, an Intranet or through phone or satellite communication networks.

37. A system or method in accordance with paragraph 14 (a) through (k) where a particular application involves a Master Trust, a Sub-Trust or a special purpose standalone trust or structured finance product or method.

38. A system or method in accordance with paragraph 15 which causes the amount so reserved or blocked to immediately become unavailable to the account holder for a pre-set or indefinite period of time, as agreed, regardless of the type of transaction, and regardless of whether the Trustee is required or not to make legally-binding representations to an unrelated third-party, and whether or not such event pertains to an escrow closing event.

39. A system or method in accordance with paragraph 16 where the security for the loan is done through a simple assignment or pledge of the asset or if such security interest is executed through any other form of structured finance process involving the issuance of securitized trust notes and whether such notes are rated or unrated by independent rating agencies.

40. A system or method in accordance with paragraph 20 where the transaction is a financial or non-financial one, the transaction involves two or more counterparties, and/or where the reserve set-aside is sent to an escrow account that is separate of the Trust but is managed by the Trustee.

Comparative Analysis

The table below contrasts the risk & benefits of the two types of debit cards:

| | Traditional Debit Cards | Trust-Linked Debit Cards ™ |
|---|---|---|
| | (Linked to a Bank Account) | (Linked to a Trust Sub-Account) |
| a. | A traditional debit card can only be issued | So long as an institutional Trustee serves |
| | by a licensed financial institution. | as Trustee (fiduciary) for the trust (usually |
| | | the trust affiliate of a major bank), any |
| | | corporation or individual that participates in |
| | | the trust arrangements envisioned by this |
| | | proprietary system can cause a TLD Card |
| | | to be issued in favor of other trust |
| | | participants. |
| b. | Bank clients maintain cash on deposit in a | Cardholders maintain a sub-account of a |
| | regular bank account in the name of the | master trust account at the fiduciary |
| | card holder at the card-issuing institution. | institution. Deposits are made to a trust |
| | | account rather than a bank account. The |
| | | institutional Trustee issues the card which |
| | | is automatically linked to the trust account |
| | | instead of a traditional bank account. |
| c. | Client accounts are only protected against | Because a Trustee operates in a fiduciary |
| | bank insolvency up to a maximum of | capacity, trust laws do not permit a trust |
| | $100,000 (FDIC insurance). In Canada and | bank to book trust funds as assets |
| | other countries of the world, the insured | belonging to the institution. Therefore, trust |
| | amount is much less. In the event of the | funds are completely protected from |
| | bank's default, clients with deposits in | creditors in the event the parent of the |
| | excess of the insured amount risk losing the | institutional Trustee becomes insolvent. |
| | excess amount entirely. Even the insured | |
| | limit may take some time to collect from the | |
| | insurance group. | |
| d. | Cash on deposit in a regular bank account | Trust funds are not an asset of the trust |
| | is technically considered an asset of the | bank. To benefit from this leverage banks |
| | bank that can be leveraged by the bank | are willing to pay to gain access to |
| | 10:1 in the United States and up to 20:1 in | overnight funds they can show as bank |
| | Canada.¹ | asset for their end-of-day reporting. |
| e. | Banks can re-lend clients' deposits as they | Unlike banks, the trust departments of |
| | become the bank's assets. For this reason, | banks act in a fiduciary capacity. They are |
| | banks decide what constitutes acceptable | only allowed to invest trust funds as |
| | risk and what does not. Though client | permitted by the trust agreement in pre- |
| | funds over $100k are at risk, the depositor | defined investment strategies and products. |
| | has no say in the lending practices of the | It is the asset manager that directs |
| | bank. | investments based on the criteria clearly |
| | | spelled out in the trust agreement. |
| f. | Globally, banks are only required to | Unlike a licensed banking institution, trust |
| | maintain a non-interest bearing reserve | banks cannot be subject to a “run on the |
| | deposit with their central bank. In the | bank”. Because trust funds are managed |
| | United States, this reserve requirement is a | by a fiduciary they are guaranteed to be |
| | maximum of 10% (less in Europe and | available at all times even if assets need to |
| | Canada). This means that in the event of a | be liquidated to satisfy the terms of the trust |
| | run on the bank, only 10% of deposits are | agreement. Hence, the action of one trust |
| | immediately available to satisfy the cash | participant does not affect that of the other |
| | withdrawals of depositors. | trust participants. Investments of the trust |
| | | are usually in investment grade marketable |
| | | securities and are readily convertible to |
| | | cash. |

Contrasting Investment Options

| g. | Because the fractional reserve banking | Funds in a trust account can only be |
|---|---|---|
| | system allows banks to leverage and re- | invested by the Trustee as permitted in the |
| | lend their customer deposits up to ten | trust agreement. Investment returns |
| | times, banks make a significant profit by | earned by the trust belong to the trust |
| | lending funds at retail and refinancing | Beneficiaries. As long as the trust |
| | themselves at wholesale rates in the inter- | agreement limits the investment risk to safe |
| | bank market or with the central bank. Little | investment practices and methods, the |
| | or none of this profit is passed on to the | upside potential can be maximized. |
| | bank customer. | |
| h. | Many banks offer corporate and high net | If permitted by the trust agreement, trust |
| | worth clients investment opportunities by | funds can also be made available to banks |
| | “sweeping” cash from deposit accounts to | for their own overnight settlements for a |
| | an overnight investment account. Funds | pre-agreed ROI. Such account “sweeps” |
| | are transferred to the bank at 5:00 PM | simply allow funds to be moved from the |
| | every night and returned to the client's | trust account/s to the benefit of the bank |
| | account when the bank reopens the next | overnight only. Sweep instructions may be |
| | business day. This process enables the | altered at any time. When trust funds are |
| | depositor to earn interest on overnight | swept to the bank, such funds become |
| | investments. Though the bank pays market | available to the bank to be booked as an |
| | rate returns (low by comparison to | asset of the bank for overnight reporting |
| | overnight settlement), any return is better | purposes. |
| | than none. | |
| i. | Many brokerage firms and/or banks offer to | If permitted by the trust agreement, trust |
| | pay high net-worth individuals, corporate | funds can be aggregated and swept to an |
| | clients and institutional funds above | overnight investment account that would |
| | average returns for the privilege of being | then permit securities firms to clear and |
| | able to sweep clients' funds for overnight | settle securities or foreign exchange |
| | settlements of securities transactions | transactions. In that a large number of |
| | involving “repo” and “reverse repo” | small accounts can be aggregated for |
| | strategies. Such agreements yield higher | overnight placement, such large pool of |
| | returns, but are normally off-limit to small | funds would quickly become an attractive |
| | investors, who are rarely even aware that | source of business for financial institutions |
| | such opportunities exist. | that compete for the trust's overnight cash |
| | | business. |
| ¹Central banking regulations require each bank to maintain a portion of its cash deposits in a non-interest earning account at the central bank. This reserve set-aside is to protect depositors in case of a run on the bank. Larger banks are often required to maintain larger reserves than smaller ones due to increased liquidity risk. Bank reserves, also known as fractional reserves, are | | |
| # a tool of central bank monetary policy to tighten or loosen its credit policy. A reserve requirement of 10% simply means that the bank can only lend out $90 on a $100 deposit ($10 is kept in reserve by the bank). When re-deposited in the bank by the borrower, the $90 loan becomes a new deposit that can be re-lent again at 90% ($81). This process can continue until a net zero effect is achieved. | | |
| # This “multiplier” effect of money is also referred to as leverage, because a $100 cash deposit can be leveraged into loans totaling $900, so long as the bank's capital ratios (Tier I and Tier II capital) are within the accepted guidelines. | | |

The specific embodiments of the invention as disclosed and illustrated herein are not to be considered in a limiting sense as numerous variations are possible. The subject matter of this disclosure includes all novel and non-obvious combinations and sub-combinations of the various features, elements, methods, functions and/or properties disclosed herein. No single feature, function, element or property of the disclosed embodiments is essential. The following claims define certain combinations and sub-combinations which are regarded as novel and non-obvious. Other combinations and sub-combinations of features, functions, elements, methods and/or properties may be claimed through amendment of the present claims or presentation of new claims in this or a related application. Such claims, whether they are different, broader, narrower or equal in scope to the original claims, are also regarded as included within the subject matter of the disclosure.

I claim;

1. A revenue-producing debit card system for users who have bank accounts, comprising:
a trust account; and
plural debit cards, each being linked to a trust account that allows overnight balances to be invested at a profit for the benefit of the user.

2. The system of claim 1, further including a link between a bank account of a user, a debit card of the user, and the trust account, so that while the debit card is linked to a bank account that is a pass-through, net zero balance bank account.

3. The system of claim 2 wherein the trust account includes a trust sub-account of the user, and wherein the cash balance required to settle card transactions of the user is each time transferred from the trust sub-account of the user.

4. The system of claim 3 wherein the bank account is used only to book a simultaneous debit and credit for the bank account each time the debit card is used by the user at a remote merchant location, and to report card activity usage.
